(19) United States
(12) Patent Application Publication
(10) Pub. No.: US 2025/0390721 A1
(43) Pub. Date: Dec. 25, 2025

(54) METHOD AND SYSTEM FOR INFERENCING LARGE LANGUAGE MODEL ADAPTED FOR SPECIFIC TASKS

(71) Applicant: L&T TECHNOLOGY SERVICES LIMITED, Chennai (IN)

(72) Inventors: SUDHIR BHADAURIA, Ahmedabad (IN); VIKRAM SUBRAMANI, Krishnagiri (IN)

(21) Appl. No.: 18/940,897

(22) Filed: Nov. 8, 2024

(30) Foreign Application Priority Data
Jun. 20, 2024 (IN) 202441047445

(51) Int. Cl. G06N 3/0475

(52) U.S. Cl. CPC G06N 3/0475

(57) ABSTRACT

A method and a system for inferencing large language model (LLM) is disclosed. A processor receives a pretrained LLM, a plurality of pretrained adapters corresponding to a plurality of tasks, one or more required tasks, and a user input for each of the one or more required tasks. A set of layers are extracted from the pretrained LLM based on an identification of a set of target layers from the plurality of pretrained adapters. The set of layers are initialized as a set of shared layers for each of the plurality of pretrained adapters. One or more task specific models are created based on the one or more required tasks. The user input is inferenced for each of the one or more required tasks using the one or more task specific models.

### TECHNICAL FIELD

This disclosure relates generally to large language model and more particularly to a method and system for inferencing large language model adapted for specific tasks.

### BACKGROUND

Large Language Models (LLMs) are artificial intelligence algorithm trained on vast amounts of text data to understand and generate human-like text. They are commonly used for various natural language processing (NLP) tasks such as text generation, translation, and summarization. LLMs achieve the state-of-the-art performance by leveraging deep learning architectures that can capture complex linguistic patterns and semantic nuances. To enhance their adaptability and performance across diverse applications, these models often use adapters-small, trainable modules that can be inserted into pre-trained models to modify their behaviour for specific tasks without retraining the entire model.

Despite their remarkable capabilities, deploying LLMs in real-world scenarios presents several challenges. One significant issue is the need to handle multiple tasks simultaneously without duplicating the LLMs, which is resource-intensive and inefficient. Conventional systems typically address the problem of task-specific inferencing in LLMs through switching trainable modules (also referred to as adapters) sequentially. In this approach, when a new task is required, the system unloads the current trainable module and loads the new one. This system conserves memory, as only one adapter is loaded at any given time. However, the drawback is the increased response time due to the overhead associated with loading and unloading adapters.

Therefore, there is a requirement for a methodology to inference large language model (LLM) adapted for specific tasks.

### SUMMARY OF THE INVENTION

In an embodiment, a method of inferencing large language model (LLM) is disclosed. The method may include receiving, by a processor, a pretrained LLM, a plurality of pretrained adapters corresponding to a plurality of tasks, one or more required tasks, and a user input for each of the one or more required tasks. The method may further include extracting, by the processor, a set of layers from the pretrained LLM based on an identification of a set of target layers from the plurality of pretrained adapters. In an embodiment, the set of target layers may be one or more layers from a plurality of layers of the pretrained LLM where each of the plurality of pretrained adapters may be added. The method may further include initializing, by the processor, the set of layers as a set of shared layers for each of the plurality of pretrained adapters. The method may further include creating, by the processor, one or more task specific models based on the one or more required tasks. In an embodiment, each of the plurality of task specific models may be associated with a corresponding pretrained adapter for a corresponding task. In an embodiment, the plurality of task specific models may be created based on the set of shared layers and the plurality of pretrained adapters. The method may further include inferencing, by the processor, the user input for each of the one or more required tasks using the one or more task specific models.

In another embodiment, a system for inferencing large language model (LLM) adapted for specific tasks is disclosed. The system may include a processor and a memory communicably coupled to the processor, wherein the memory may store processor-executable instructions, which when executed by the processor may cause the processor to receive a pretrained LLM, a plurality of pretrained adapters corresponding to a plurality of tasks, one or more required tasks, and a user input for each of the one or more required tasks. The processor may further extract a set of layers from the pretrained LLM based on an identification of a set of target layers from the plurality of pretrained adapters. In an embodiment, the set of target layers may be one or more layers from a plurality of layers of the pretrained LLM where each of the plurality of pretrained adapters may be added. The processor may further initialize the set of layers as a set of shared layers for each of the plurality of pretrained adapters. The processor may further create one or more task specific models based on the one or more required tasks. In an embodiment, each of the plurality of task specific models may be associated with a corresponding pretrained adapter for a corresponding task. In an embodiment, the plurality of task specific models may be created based on the set of shared layers and the plurality of pretrained adapters. The processor may further inference the user input for each of the one or more required tasks using the one or more task specific models.

It is to be understood that both the foregoing general description and the following detailed description are exemplary and explanatory only and are not restrictive of the invention, as claimed.

### BRIEF DESCRIPTION OF THE DRAWING

The accompanying drawings, which are incorporated in and constitute a part of this disclosure, illustrate exemplary embodiments and, together with the description, serve to explain the disclosed principles.

FIG. 1 is a block diagram of an exemplary system for inferencing large language model (LLM), in accordance with an embodiment of the present disclosure.

FIG. 2 is a schematic diagram of a computing device of the exemplary system of FIG. 1, in accordance with an embodiment of the present disclosure.

FIG. 3 is a flow diagram of a methodology of inferencing large language model (LLM) adapted for specific tasks, in accordance with an embodiment of present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered exemplary only, with the true scope being indicated by the following claims. Additional illustrative embodiments are listed.

Further, the phrases “in some embodiments”, “in accordance with some embodiments”, “in the embodiments shown”, “in other embodiments”, and the like mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope being indicated by the following claims.

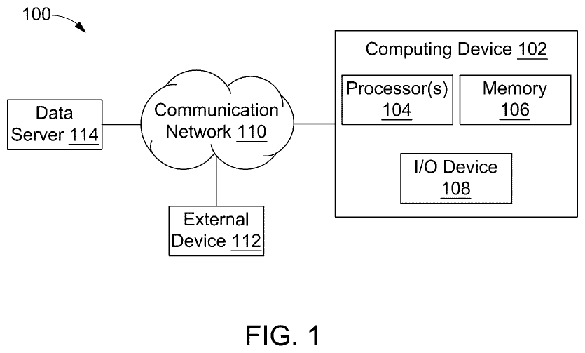

Referring now to FIG. 1, a block diagram of an exemplary system 100 for inferencing large language model (LLM) is illustrated, in accordance with an embodiment of the present disclosure. The system 100 may include a computing device 102, an external device 112, and a data server 114 communicably coupled to each other through a wired or wireless communication network 110. The computing device 102 may include a processor 104, a memory 106 and an input/output (I/O) device 108.

In an embodiment, examples of processor(s) 104 may include, but are not limited to, an Intel® Itanium® or Itanium 2 processor(s), or AMD® Opteron® or Athlon MP® processor(s), Motorola® lines of processors, Nvidia®, FortiSOC™, system on a chip processors or other future processors.

In an embodiment, the memory 106 may store instructions that, when executed by the processor 104, and cause the processor 104 to adapt the LLM for specific tasks, as will be discussed in greater detail herein below. In an embodiment, the memory 106 may be a non-volatile memory or a volatile memory. In an embodiment, the memory 106 may also store a single module or a combination of different modules to adapt the LLM for specific tasks. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

In an embodiment, the I/O device 108 may comprise of variety of interface(s), for example, interfaces for data input and output devices, and the like. The I/O device 108 may facilitate inputting of instructions by a user communicating with the computing device 102. In an embodiment, the I/O device 108 may be wirelessly connected to the computing device 102 through wireless network interfaces such as Bluetooth®, infrared, or any other wireless radio communication known in the art. In an embodiment, the I/O device 108 may be connected to a communication pathway for one or more components of the computing device 102 to facilitate the transmission of inputted instructions and output results of data generated by various components such as, but not limited to, processor(s) 104 and memory 106.

In an embodiment, the data server 114 may be enabled in a remote cloud server or a co-located server and may include a database to store pretrained LLM, pretrained adapters, and other data necessary for the system 100 such as, but not limited to required tasks. In an embodiment, the data server 114 may store data input by an external device 112 (e.g., target layers, inference type) or output generated by the computing device 102. It is to be noted that within the data server 114, a pretrained LLM is stored for use by the computing device 102. In an embodiment, examples of the pretrained LLM may include, but are not limited to, zephyr, code LLAMA, GPT, etc. The pretrained LLM stored within the data server 114 serves as a foundational component for various computational tasks and applications. In an embodiment, the computing device 102 may be communicably coupled with the data server 114 through the communication network 110.

In an embodiment, the communication network 110 may be a wired or a wireless network or a combination thereof. The communication network 110 can be implemented as one of the different types of networks, such as but not limited to, ethernet IP network, intranet, local area network (LAN), wide area network (WAN), or a Metropolitan Area Network (MAN). Various devices in the system 100 may be configured to connect to the communication network 110, in accordance with various wired and wireless communication protocols. Examples of such wired and wireless communication protocols may include, but are not limited to, a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols. Further the communication network 110 can include a variety of network devices, including routers, bridges, servers, computing devices, storage devices, and the like.

In an embodiment, the computing device 102 may receive a plurality of inputs from the external device 112 through the communication network 110. In an embodiment, the computing device 102 and the external device 112 may be a computing system, including but not limited to, a laptop computer, a desktop computer, a notebook, a workstation, a server, a portable computer, a handheld or a mobile device. In an embodiment, the computing device 102 may be, but not limited to, in-built into the external device 112 or may be a standalone computing device.

In an embodiment, the computing device 102 may perform various processing in order to inference large language model adapted for specific tasks. By way of an example, the computing device 102 may receive the pretrained LLM, a plurality of pretrained adapters corresponding to a plurality of tasks, one or more required tasks, and a user input for each of the one or more required tasks. In an embodiment, the pretrained LLM may be a trained LLM for a specific domain (e.g., finance). In an embodiment, the plurality of tasks may include, but is not limited to, text summarization, question & answering, and text translation related to text data (e.g., financial reports). In an embodiment, the plurality of pretrained adapters may be trained for the plurality of tasks.

The computing device 102 may further extract a set of layers from the pretrained LLM based on an identification of a set of target layers from the plurality of pretrained adapters. In an embodiment, the set of target layers may be one or more layers from a plurality of layers of the pretrained LLM where each of the plurality of adapters may be added. In an embodiment, the set or target layers may be by default selected from one or more of the plurality of layers of the pretrained LLM. It should be noted that the default selection may be based on model complexity, resource constraints, and hardware capabilities. Alternatively, in an embodiment, the set of target layers may be specified by the user based on model complexity, resource constraints, and hardware capabilities as well as based on their preference and domain experience. Further, for example, in an embodiment, the user may modify the default selection based on their understanding of model complexity and resource constraints, as well as based on their preference and domain experience.

The computing device 102 may subsequently initialize the set of layers (i.e., the extracted layers) as a set of shared layers for each of the plurality of adapters.

The computing device 102 may further receive an inferencing type. In an embodiment, the inferencing type may include one of a sequential and a parallel inferencing. The computing device 102 may further create one or more task specific models based on the one or more required tasks and the inferencing type. In an embodiment, each of the plurality of task specific models may be associated with a corresponding pretrained adapter for a corresponding task. In an embodiment, the plurality of task specific models may be created based on the set of shared layers and the plurality of pretrained adapters.

The computing device 102 may further inference the user input for each of the one or more required tasks using the one or more task specific models. In an embodiment the sequential inferencing may be performed by sequential loading a pretrained adapter on a corresponding task specific model based on a corresponding required task for each of the one or more required tasks. In an embodiment, the parallel inferencing may be performed by parallel loading two or more pretrained adapters on two or more corresponding task specific models based on two or more required tasks.

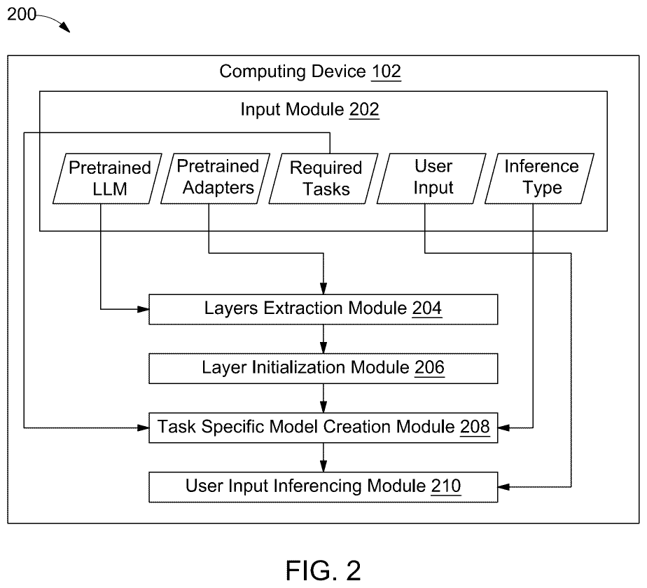

Referring now to FIG. 2, a schematic diagram 200 of the computing device 102 is illustrated, in accordance with an embodiment of the present disclosure. In an embodiment, the computing device 102 may include an input module 202, a layer extraction module 204, a layer initialization module 206, a task specific model creation module 208, and a user input inferencing module 210.

The input module 202 may receive a pretrained LLM, a plurality of pretrained adapters corresponding to a plurality of tasks, one or more required tasks, an inferencing type, and a user input for each of the one or more required tasks as an input. It should be noted that the input may be indicated or provided by a user via the I/O device 108. For example, the user may indicate the file path for the pretrained LLM, and the plurality of pretrained adapters. In an embodiment, examples of the pretrained LLM may include, but are not limited to, zephyr, code LLAMA, GPT, etc. In an embodiment, the inferencing type may include one of a sequential and a parallel inferencing.

In an embodiment, the pretrained LLM may be trained LLM for a general purpose. In an embodiment, each of the plurality of adapters may be associated with a corresponding task. In an embodiment, the task may include, but is not limited to, text summarization, question & answering, and text translation corresponding to a specific domain.

The layer extraction module 204 may extract a set of layers from the pretrained LLM based on an identification of a set of target layers from the plurality of pretrained adapters. It should be noted that, in an embodiment, the set of layers (i.e., the extracted layers) may be a replication of the target layers of the pretrained LLM. In an embodiment, the set of target layers may be one or more layers from a plurality of layers of the pretrained LLM where each of the plurality of adapters may be added. In an embodiment, the set or target layers may be by default selected from one or more of the plurality of layers of the pretrained LLM. It should be noted that the default selection may be based on model complexity, resource constraints, and hardware capabilities. Alternatively, in an embodiment, the set of target layers may be specified by the user based on model complexity, resource constraints, and hardware capabilities as well as based on their preference and domain experience. For example, in an embodiment, the user may modify the default selection based on their understanding of model complexity and resource constraints, as well as based on their preference and domain experience.

The layer initialization module 206 may subsequently initialize the set of layers (i.e., the extracted layers) as a set of shared layers for each of the plurality of adapters. In other words, the extracted layers are shared among each of the plurality of adapters. Such sharing may increase resource unitization efficiency as well as decrease the training time.

The task specific model creation module 208 may further create one or more task specific models based on the one or more required tasks and the inferencing type. In other words, each task specific model may include a corresponding adapter and the set of shared layers. In an embodiment, each of the plurality of task specific models may be associated with a corresponding pretrained adapter for a corresponding task. In an embodiment, the plurality of task specific models may be created based on the set of shared layers and the plurality of pretrained adapters.

Accordingly, the user input inferencing module 210 may further inference the user input for each of the one or more required tasks using the one or more task specific models. In an embodiment the sequential inferencing may be performed by sequential loading a pretrained adapter on a corresponding task specific model based on a corresponding required task for each of the one or more required tasks. In an embodiment, the parallel inferencing may be performed by parallel loading two or more pretrained adapters on two or more corresponding task specific models based on two or more required tasks.

In an exemplary scenario, a user may input text to be summarized and translated simultaneously, the computing device 102 may create parallel task-specific models for text summarization and text translation, processing both required tasks (i.e., summarization and translation) at the same time. In accordance with the exemplary scenario, the input module 202 may receive a pretrained GPT model, adapters for text summarization and text translation, tasks for text summarization and text translation, parallel inferencing type, and a document to be processed. Further, the layer extraction module 204 may identify and extracts layers from the GPT model and may create a set of shared layers. The layer initialization module 206 may initialize these layers for both the text summarization and the text translation adapters. Further, the task-specific model creation module 208 may generate two task-specific models (i.e., one for text summarization and another for translation), both utilizing the set of shared layers. Further, the user input inferencing module 210 may perform parallel inferencing, processing the document through models simultaneously, providing the summarized text and the translated text simultaneously.

It should be noted that all such aforementioned modules 202-210 may be represented as a single module or a combination of different modules. Further, as will be appreciated by those skilled in the art, each of the modules 202-210 may reside, in whole or in parts, on one device or multiple devices in communication with each other. In some embodiments, each of the modules 202-210 may be implemented as dedicated hardware circuit comprising custom application-specific integrated circuit (ASIC) or gate arrays, off-the-shelf semiconductors such as logic chips, transistors, or other discrete components. Each of the modules 202-210 may also be implemented in a programmable hardware device such as a field programmable gate array (FGPA), programmable array logic, programmable logic device, and so forth. Alternatively, each of the modules 202-210 may be implemented in software for execution by various types of processors (e.g. processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for inferencing large language model adapted for specific tasks. For example, the exemplary system 100 and the associated computing device 102 may inference large language models adapted for specific tasks by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

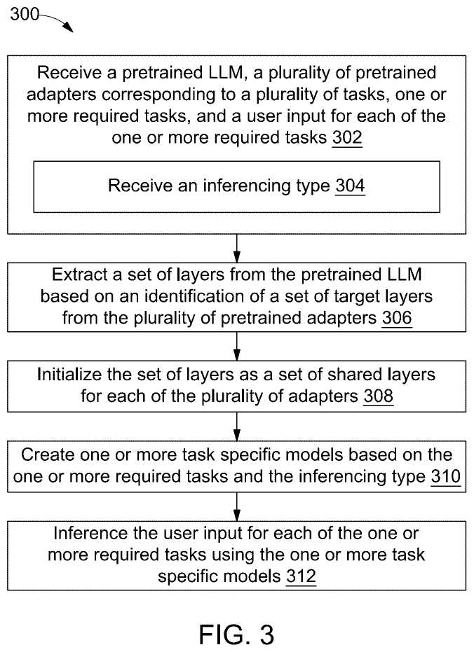

Referring to FIG. 3, a flow diagram of a methodology 300 of inferencing large language model (LLM) adapted for specific tasks is illustrated, in accordance with an embodiment of present disclosure. FIG. 3 is explained in conjunction with FIGS. 1 and 2. In an embodiment, the methodology 300 may include a plurality of steps that may be performed by various modules of the computing device 102 so as to inference LLM adapted for specific tasks.

At step 302, the computing device 102 may receive the pretrained LLM, a plurality of pretrained adapters corresponding to a plurality of tasks, one or more required tasks, and a user input for each of the one or more required tasks. In an embodiment, the pretrained LLM may be a trained LLM for a general purpose. In an embodiment, the plurality of tasks may include, but is not limited to, text summarization, question & answering, and text translation. In an embodiment, the plurality of pretrained adapters may be trained for the plurality of tasks. Further, in an embodiment, at sub-step 304, the computing device 102 may receive an inferencing type. In an embodiment, the inferencing type may include one of a sequential and a parallel inferencing.

Further at step 306, the computing device 102 may further extract a set of layers from the pretrained LLM based on an identification of a set of target layers from the plurality of pretrained adapters. As discussed above, the set of target layers may be one or more layers from a plurality of layers of the pretrained LLM where each of the plurality of adapters may be added. In an embodiment, the set or target layers may be by default selected from one or more of the plurality of layers of the pretrained LLM. It should be noted that the default selection may be based on model complexity, resource constraints, and hardware capabilities. Alternatively, in an embodiment, the set of target layers may be specified by the user based on model complexity, resource constraints, and hardware capabilities as well as based on their preference and domain experience. For example, in an embodiment, the user may modify the default selection based on their understanding of model complexity and resource constraints, as well as based on their preference and domain experience.

Further at step 308, the computing device 102 may subsequently initialize the set of layers as a set of shared layers for each of the plurality of adapters.

Further at step 310, the computing device 102 may further create one or more task specific models based on the one or more required tasks and the inferencing type. In an embodiment, each of the plurality of task specific models may be associated with a corresponding pretrained adapter for a corresponding task. In an embodiment, the plurality of task specific models may be created based on the set of shared layers and the plurality of pretrained adapters.

Further at step 312, the computing device 102 may further inference the user input for each of the one or more required tasks using the one or more task specific models. In an embodiment the sequential inferencing may be performed by sequential loading a pretrained adapter on a corresponding task specific model based on a corresponding required task for each of the one or more required tasks. In an embodiment, the parallel inferencing may be performed by parallel loading two or more pretrained adapters on two or more corresponding task specific models based on two or more required tasks.

As will be appreciated by those skilled in the art, the techniques described in the various embodiments discussed above are not routine, or conventional, or well-understood in the art. The techniques discussed above provide for inferencing LLM adapted for specific tasks.

The disclosed method and system dynamically manage the loading and unloading of adapters, ensuring that only the necessary adapters are active at any given time. This approach significantly reduces the memory footprint, making it feasible to deploy LLMs with multiple task-specific adapters even on devices with limited memory capacity.

The disclosed method and system minimize the latency associated with switching between tasks by leveraging a more efficient management mechanism, the disclosed method and system rapidly activates the required adapters without incurring the overhead of repeated loading and unloading processes. This reduction in latency is particularly beneficial for real-time applications where fast response times are crucial. By optimizing memory usage and reducing latency, the disclosed method and system leads to cost savings in both hardware and operational expenses.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described the method and system for inferencing LLM adapted for specific tasks. The illustrated steps are set out to explain the exemplary embodiments shown, and it should be anticipated that ongoing technological development will change the manner in which particular functions are performed. These examples are presented herein for the purpose of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

It is intended that the disclosure and examples be considered as exemplary only, with a true scope of disclosed embodiments being indicated by the following claims.

What is claimed is:

1. A method of inferencing large language model (LLM) adapted for specific tasks, the method comprising:
receiving, by a processor, a pretrained LLM, a plurality of pretrained adapters corresponding to a plurality of tasks, one or more required tasks, and a user input for each of the one or more required tasks;
extracting, by the processor, a set of layers from the pretrained LLM based on an identification of a set of target layers from the plurality of pretrained adapters, wherein the set of target layers are one or more layers from a plurality of layers of the pretrained LLM where each of the plurality of pretrained adapters is added;
initializing, by the processor, the set of layers as a set of shared layers for each of the plurality of pretrained adapters;
creating, by the processor, one or more task specific models based on the one or more required tasks, wherein each of the plurality of task specific models is associated with a corresponding pretrained adapter for a corresponding task, and wherein the plurality of task specific models is created based on the set of shared layers and the plurality of pretrained adapters; and
inferencing, by the processor, the user input for each of the one or more required tasks using the one or more task specific models.

2. The method of claim 1, comprising:
receiving, by the processor, an inferencing type, wherein the inferencing type comprises one of a sequential inferencing and a parallel inferencing, and wherein creating the one or more task specific models is based on the inferencing type.

3. The method as claimed in claim 2, wherein the sequential inferencing is performed by sequentially loading a pretrained adapter on a corresponding task specific model based on a corresponding required task for each of the one or more required tasks, and wherein the parallel inferencing is performed by parallelly loading two or more pretrained adapters on two or more corresponding task specific models based on two or more required tasks.

4. A system for inferencing from large language model (LLM) adapted for specific tasks, comprising:
a processor,
a memory communicably coupled to the processor, wherein the memory stores processor-executable instructions, which, on execution, cause the processor to:
receive a pretrained LLM, a plurality of pretrained adapters corresponding to a plurality of tasks, one or more required tasks, and a user input for each of the one or more required tasks;
extract a set of layers from the pretrained LLM based on an identification of a set of target layers from the plurality of pretrained adapters, wherein the set of target layers are one or more layers from a plurality of layers of the pretrained LLM where each of the plurality of pretrained adapters is added;
initialize the set of layers as a set of shared layers for each of the plurality of pretrained adapters;
create one or more task specific models based on the one or more required tasks, wherein each of the plurality of task specific models is associated with a corresponding pretrained adapter for a corresponding task, and wherein the plurality of task specific models is created based on the set of shared layers and the plurality of pretrained adapters; and
inference the user input for each of the one or more required tasks using the one or more task specific models.

5. The system of claim 4, wherein processor-executable instructions, which, on execution, cause the processor to:
receive an inferencing type, wherein the inferencing type comprises one of a sequential inferencing and a parallel inferencing, and wherein creating the one or more task specific models is based on the inferencing type.

6. The system of claim 5, wherein the sequential inferencing is performed by sequentially loading a pretrained adapter on a corresponding task specific model based on a corresponding required task for each of the one or more required tasks, and wherein the parallel inferencing is performed by parallelly loading two or more pretrained adapters on two or more corresponding task specific models based on two or more required tasks.

7. A non-transitory computer-readable medium storing computer-executable instructions for inferencing large language model (LLM) adapted for specific tasks, the computer-executable instructions configured for:
receiving a pretrained LLM, a plurality of pretrained adapters corresponding to a plurality of tasks, one or more required tasks, and a user input for each of the one or more required tasks;
extracting a set of layers from the pretrained LLM based on an identification of a set of target layers from the plurality of pretrained adapters, wherein the set of target layers are one or more layers from a plurality of layers of the pretrained LLM where each of the plurality of pretrained adapters is added;
initializing the set of layers as a set of shared layers for each of the plurality of pretrained adapters;
creating one or more task specific models based on the one or more required tasks, wherein each of the plurality of task specific models is associated with a corresponding pretrained adapter for a corresponding task, and wherein the plurality of task specific models is created based on the set of shared layers and the plurality of pretrained adapters; and
inferencing the user input for each of the one or more required tasks using the one or more task specific models.

8. The non-transitory computer-readable medium of claim 7, wherein the computer-executable instructions are further configured for:
receiving an inferencing type, wherein the inferencing type comprises one of a sequential inferencing and a parallel inferencing, and wherein creating the one or more task specific models is based on the inferencing type.

9. The non-transitory computer-readable medium of claim 8, wherein the sequential inferencing is performed by sequentially loading a pretrained adapter on a corresponding task specific model based on a corresponding required task for each of the one or more required tasks, and wherein the parallel inferencing is performed by parallelly loading two or more pretrained adapters on two or more corresponding task specific models based on two or more required tasks.
